(19) United States
(12) Patent Application Publication
(10) Pub. No.: US 2011/0236692 A1
(43) Pub. Date: Sep. 29, 2011

(54) FLUOROELASTOMER COMPOSITIONS HAVING SELF-BONDING CHARACTERISTICS AND METHODS OF MAKING SAME

(75) Inventors: Jiazhong Luo, Lansdale, PA (US); Eugene Gurevich, Coopersburg, PA (US); Joan Eberhard, Blooming Glen, PA (US)

(73) Assignee: Greene, Tweed of Delaware, Inc., Wilmington, DE (US)

(21) Appl. No.: 13/071,635

(22) Filed: Mar. 25, 2011

Related U.S. Application Data
(60) Provisional application No. 61/318,770, filed on Mar. 29, 2010.

(51) Int. Cl. B32B 27/04; B32B 27/06; C08F 14/26; C08L 27/22; C08K 3/36; B32B 27/20

(52) U.S. Cl. 428/421; 525/276; 525/199; 524/502; 156/242

(57) ABSTRACT

Self-bonding curable fluoroelastomer compositions are provided wherein the compositions including a) a fluoropolymer composition having at least one curable fluoropolymer; and b) a compound selected from the group consisting of aluminum acrylates, silicon acrylates, and ammonia acrylates, wherein the self-bonding curable fluoroelastomer composition is able to bond directly to a substrate. Bonded structures formed of such self-bonding compositions and a substrate having a surface bonded thereto are also described herein along with a method for bonding a self-bonding curable fluoroelastomer composition to a substrate surface. The fluoroelastomers herein may encompass both non-fully fluorinated (FKM) and fully fluorinated (FFKM) elastomers.

### CROSS-REFERENCE TO RELATED APPLICATIONS

This patent application claims the benefit under 35 U.S.C. §119(e) of U.S. provisional patent application No. 61/318,770, filed Mar. 29, 2010, the disclosure of which is incorporated herein by reference in its entirety.

### BACKGROUND OF THE INVENTION

1. Field of the Invention

The invention relates to the field of bonding of fluoroelastomeric materials, including perfluoroelastomeric materials, to surfaces, including metallic surfaces which may be used in semiconductor manufacturing processes.

2. Description of Related Art

Semiconductor manufacturing involves the use of various sealed process chambers, and may involve cleanroom environments designed to avoid contamination and particulation that can impact the resulting manufactured products (semiconductor wafers and chips). Such process equipment typically includes gates and doors, e.g., slit valve doors, which close off the chambers from the surrounding environment. Such doors and gates generally include seals, gaskets and o-rings. The materials used to make such seals, gaskets and o-rings are usually formed of a fluoropolymeric or fluoroelastomeric material, and in some cases for highly contamination resistant seals, are formed of perfluoroelastomeric material. Such doors and gates are commonly used with process reaction chambers in the semiconductor industry allowing for opening and closing of a chamber.

In the semiconductor industry, processes such as chemical vapor deposition, plasma deposition, etching and the like are typically used. Such processes require the use of vacuum chambers and similar reactors in which harsh chemicals, high-energy plasmas and other corrosive materials are used creating very harsh environments. Plasmas are defined as a fourth state of matter distinct from solid, liquid or gas and are present in stars and fusion reactors. Gases become plasmas when they are heated until the atoms lose all their electrons, leaving a highly electrified collection of nuclei and free electrons.

Semiconductor process steps generally occur in an isolated environment in a series of interconnecting reaction and other chambers through which chips, chip wafer and other substrates can move or be moved robotically. When moving about and through such a series of chambers, in operation, there are also associated with this equipment various doors, gates, and/or valves. One such door includes a slit valve, which are made typically so as to have a resilient sealing ring that ensures adequate sealing of openings to a reaction chamber. Such sealing is important due to the harsh nature of the reactants within the chamber, i.e., to keep such chemicals safely within the chamber and to keep impurities from outside the chamber from getting in during a reaction which could impact the purity of the resulting reaction product(s).

Such parts can also be provided ready to use, such as providing a slit valve door or gate with a seal or gasket already in place on the door, such as in a pre-molded groove sized to receive a seal, gasket or O-ring of corresponding shape in facing engagement. Thus, the doors or gates can be easily installed on the process equipment. Such seals can be bonded in place, but are not typically “sealed” properly to the door surface without use of a bonding agent.

Fluorine-containing elastomers (known as FKMs), are used in such seals in various environments requiring resistance to harsh chemicals. In the semiconductor area, it is particularly common to use perfluoroelastomers to exhibit excellent chemical resistance, solvent resistance and heat resistance, and therefore such elastomers are widely used for sealing materials when in place in the harshest of environments. Perfluoroelastomeric materials are known for their chemical resistance, plasma resistance, and when used in compositions having typical filler or reinforcing systems for acceptable compression set resistance levels and mechanical properties. As such, they have been applied for many uses, including for use as elastomeric sealing materials in applications where a seal or gasket will be subject to highly corrosive chemicals and/or extreme operating conditions, and for use in forming molded parts that are capable of withstanding deformation.

FFKMs are also well known for use in the semiconductor manufacturing industry as sealing materials due to their chemical and plasma resistance. Such materials are typically prepared from perfluorinated monomers, including at least one perfluorinated cure site monomer. The monomers are polymerized to form a perfluorinated polymer having the cure sites from the cure site monomer(s) and then cured (cross-linked) to form an elastomer. Typical FFKM compositions include a polymerized perfluoropolymer as noted above, a curing agent that reacts with the reactive cure site group on the cure site monomer, and any desired fillers. The cured perfluoroelastomer exhibits typical elastomeric characteristics.

FFKMs are generally known for use as O-rings and related sealing parts for high-end sealing applications due to their high purity, excellent resistance to heat, plasma, chemicals and other harsh environments. Industries that require their use in such environments include semiconductor, aerospace, chemical and pharmaceutical.

As is recognized in the art, different FFKM compositions may include different curing agents (curatives) depending on the type of cure site monomer (CSM) structure and corresponding curing chemistry. Such compositions may also include a variety of fillers and combinations of fillers to achieve target mechanical properties, compression set or improved chemical and plasma resistance. However, due to their largely inert chemical nature, it is not always easy to bond such FKM and FFKM materials to surfaces for forming ready-to-use parts such as gates, valves and other doors having seals pre-set therein or even to bond such seals in situ prior to use or in replacement of prior gate or door seals. There are many instances, however, when such bonded fluoroelastomer parts are put into service in the semiconductor industry in particular wherein the conditions of harsh plasma and other gases and/or the range of temperatures are not ideal for most bonding agents. For examples, high temperatures of up to about 300° C. apply in many such applications.

For semiconductor sealing applications, it is also known to provide various fillers, both inorganic and organic, to alter plasma or other chemical resistance or vary the physical properties of the seals. However, there is a balance and art involved in selecting such fillers as they have to positively impact physical properties, not significantly impact seal compression set properties and not introduce unwanted contamination as seals erode due to use over time, even seals such as FFKM seals which are highly resistant to harsh chemicals. Typical fillers in the art include carbon black, silica, alumina, fluoroplastics, barium sulfate and other plastics. Fillers used in some FFKM compositions for semiconductor applications include fluoroplastic filler particles formed of polytetrafluoroethylene (PTFE) or melt-processible perfluorinated copolymers such as copolymers of tetrafluoroethylene (TFE) and hexafluoropropylene (HFP) (also referred to as FEP-type copolymers) or of TFE and perfluoroalkylvinyl ethers (PAVEs) (known as PFA-type copolymers), particularly in nanomer-sized particles.

In preparing FKM and FFKM seals, gaskets and O-rings for use in a part, where bonding is desired, the bonding material and the surface material must adhere or otherwise be affixed to one another. Typical surfaces to which such materials are bonded include other fluoroelastomers, perfluoroelastomers or other fluoropolymers (e.g., in molding parts together, welding or splicing elastomers, or adhering fluoroelastomers to fluoropolymeric materials), metals, metal alloys, an/or other thermosetting or thermoplastic resins (such as resins suitable for use in harsh or pure environments in which FKMs or FFKMs may be put into service—semiconductor manufacturing, medical sterilization use, pharmaceutical manufacturing, and downhole tool use).

While the inert nature of fluoroelastomers (including perfluoroelastomers) is a benefit in harsh and pure environments, it presents difficulty in the fabrication of the bonded parts where the elastomer is bonded to a surface, such as in semiconductor processing gates, valves, and doors. Because of its inertness, it is difficult to achieve surface-to-elastomer bonds, such as metal-to-FFKM bonds, of sufficient strength and durability that the bond will survive in the environment for a sufficient period of time before requiring replacement or repair.

In prior art elastomer vulcanization and bonding processes, a bonding agent is manually applied with brushes onto a substrate followed by molding and post-curing of the elastomer part. With standard bonding agents, for example, those available from Lord Chemical, Cary, N.C. under the trade name Chemlok®, the resulting bonding products face challenges in surviving at processing or other application temperatures above 200° C. Use at up to about 300° C. or simply matching the application temperature if over 200° C. is not possible. Newer FFKM and other elastomer products cure at temperatures which are high. Use of traditional bonding agents can cause bonded parts to delaminate during post-curing. Bonding agents which can retain integrity at 200° C.+ and particularly at about 250° C. to about 300° C. and higher in longer continued use at sustained high temperatures are very much sought after in the semiconductor and adhesive industries for high temperature service elastomers.

U.S. Pat. No. 6,194,504 discloses a process for compounding metal salts into elastomers such that metal acrylate salts are used therein as scorch retarders.

U.S. Pat. No. 5,217,807 teaches a reinforced natural or synthetic rubber or blended rubber composition, which includes sulfur-curable elastomers with metallic fillers. Brass coated metal reinforcement blended in the elastomer is provided which may include metal acrylates as an adhesion promoter.

U.S. Pat. No. 7,514,506 B2 discloses perfluoroelastomeric compositions which may be used for bonding to a metallic surface, such as in a gate valve. The compositions include curable perfluoropolymers curable with diphenyl-based curing agents, including bisaminophenol (BOAP), curing agents, and organic cyclic colorant compounds that are metallic-free materials.

U.S. Patent Application Publication No. 2009-0018275-A1 teaches use of FFKM solvent formulations including both curable perfluoropolymers and curing agents in a solvent solution which are used as bonding agents for bonding perfluoropolymers to surfaces, such as to other perfluoropolymer surfaces, and a curable solvent coating composition capable of forming an FFKM coating for bonding to, for example, a metallic surface.

International Publication No. WO 2009/121012 A1 teaches FKM and FFKM compositions for use in harsh environments, particularly for down-hole tool use, that bond to substrates, including, e.g., metal and polymeric inert substrates. The compositions include a curable fluoropolymer, silica and an acrylate compound, and preferably a curing agent. The acrylates are described as metal acrylates or combinations of differing acrylate compounds and/or metal acrylates. Exemplary compounds listed are diacrylates, methacrylates, dimethacrylates, triacrylates, and/or tetraacrylates, and of particular use are those diacrylates and methacrylates of the heavy metals, zinc and copper. The publication notes that such compounds are known as commercial products available from, for example, Sartomer, of Exton, Pa., United States of America (tradenames, for example, SARET® SR633 and SARET® SR634. Such products are described as self-bonding materials.

While such compounds show a continued improvement in the art for increasingly better bonding agents, and self-bonding materials of increasing strength. However, not all environments are the same. In semiconductor environments, there is a particular need for self-bonding compositions of high strength that are heavy-metal free and that improve upon the bond strength achievable from standard bonding agents. Such compounds should enable strong bonds which strive to be inert or non-interfering in the semiconductor process and allow for bonding to polymeric, elastomeric and particularly to metal surfaces for metals in doors, gates, and valves known in the semiconductor processing arts, while still exhibiting durable bond strength.

### BRIEF SUMMARY OF THE INVENTION

The invention includes a self-bonding curable fluoroelastomer composition, comprising a) a fluoropolymer composition having at least one curable fluoropolymer; and b) a compound selected from the group consisting of aluminum acrylates, silicon acrylates, ammonia acrylates, and combinations thereof, wherein the self-bonding curable fluoroelastomer composition is able to bond directly to a substrate.

The curable fluoropolymer in the composition noted above may have at least two monomers and at least one curesite monomer. The at least two monomers may comprise tetrafluoroethylene and vinylidene fluoride. The fluoroelastomer composition may also include at least one direct curing agent. At least one of a co-curing agent and a cure accelerator may also be included depending on the cure system adopted. The composition may also include least two curable fluoropolymers, such as, for example, in a fluoropolymer blend.

In one embodiment herein, the fluoropolymer composition may be a perfluoropolymer composition and the least one curable fluoropolymer would thus comprise a curable perfluoropolymer. In that case, the curable perfluoroelastomer composition may also comprise at least one curing agent. In a further embodiment, the curable perfluoropolymer may comprise tetrafluoroethylene, a perfluoroalkylvinylether, and at least one curesite monomer. Further, at least two curable perfluoropolymers may be used in the composition, such as in a perfluoropolymer blend.

At least one filler may also optionally be provided to the composition, such as those from the group consisting of fluoropolymer powders, fluoropolymer micropowders, core-shell fluoropolymer fillers, fluoropolymer nanopowders, cross-linkable fluoroplastic fillers, carbon black, fluorographite, silica, silicates, glass fiber, glass spheres, fiberglass, calcium sulfate, asbestos, boron fibers, ceramic fibers, aluminum hydroxide, barium sulfate, calcium carbonate, magnesium carbonate, alumina, aluminum nitride, borax, perlite, zinc terephthalate, silicon carbide platelets, silicon carbide whiskers, wollastonite, calcium terephthalate, fullerene tubes, Hectorite, talc, mica, carbon nanotubes.

The self-bonding fluoroelastomer composition of the above-noted embodiment is preferably able to bond directly to a substrate selected from the group consisting of ceramic, metals, metal alloys, semiconductors, and polymers. The self-bonding fluoroelastomer composition is also preferably able to bond directly to alumina, sapphire, boron, silicon, germanium, arsenic, antimony, tellurium, polonium, yttria and yttrium-containing compounds, anodized aluminum, aluminum, stainless steel, and polytetrafluoroethylene.

In another embodiment herein, the invention includes a self-bonding perfluoroelastomer composition comprising, a) a perfluoropolymer composition comprising at least one curable perfluoropolymer, wherein the at least one curable perfluoropolymer comprises tetrafluoroethylene, a perfluoroalkylvinylether and at least one curesite monomer; b) at least one curing agent; and c) a compound selected from the group consisting of aluminum acrylates, silicon acrylates, ammonia acrylates, and combinations thereof, wherein the self-bonding curable perfluoroelastomer composition is able to bond directly to a substrate.

In the above-noted embodiment, the at least one curing agent may be a peroxide-based curing agent and the at least one curesite monomer would thus have a functional group that is capable of crosslinking with the peroxide-based curing agent. At least one of a co-curing agent and a cure accelerator may also be included in the composition. The at least one perfluoropolymer may be at least one of a terpolymer and a tetrapolymer. Further, at least two curable perfluoropolymers may be provided such as in a perfluoropolymer blend.

At least one filler may be optionally included, such as one from the group consisting of fluoropolymer powders, fluoropolymer micropowders, core-shell fluoropolymer fillers, fluoropolymer nanopowders, cross-linkable fluoroplastic fillers, carbon black, fluorographite, silica, silicates, barium sulfate, calcium carbonate, magnesium carbonate, alumina, aluminum nitride, and carbon nanotubes.

The self-bonding perfluoroelastomer composition of the above-noted embodiment is preferably able to bond directly to a substrate selected from the group consisting of ceramic, metals, metal alloys, semiconductors, and polymers.

Similarly, the self-bonding perfluoroelastomer composition is preferably able to bond directly to alumina, sapphire, boron, silicon, yttria, yttrium-containing compounds, germanium, arsenic, antimony, tellurium, polonium, anodized aluminum, aluminum, stainless steel, and polytetrafluoroethylene.

In a further embodiment herein, the invention includes a bonded structure, comprising: a) a substrate having a surface; and b) a fluoroelastomer bonded to the surface of the substrate, wherein the fluoroelastomer comprises a compound selected from the group consisting of aluminum acrylates, silicon acrylates, ammonia acrylates, and combinations thereof, and wherein the fluoroelastomer is bonded directly to the substrate. The substrate in the structure may be selected from the group consisting of ceramic, metals, metal alloys, semiconductors, and polymers and the fluoroelastomer may be a perfluoroelastomer. The bonded structure can be a wide variety of structures, and may be selected, for example, from the group consisting of a laminated structure, a gate valve, a semiconductor chamber door, and a bonded slit valve. A second substrate may be part of the structure, wherein the second substrate has a surface, and the fluoroelastomer is also bonded to the surface of the second substrate. In such a case, the bonded structure may form a laminated structure having the fluoroelastomer bonded as a layer between the surfaces of the first substrate and the second substrate.

The invention also includes a method of bonding a fluoroelastomer to a substrate, comprising a) preparing a curable fluoropolymer composition by combining at least one curable fluoropolymer with a compound selected from the group consisting of aluminum acrylates, silicon acrylates, ammonia acrylates, and combinations thereof; b) providing a substrate having a surface; and c) heat molding the curable fluoropolymer composition to the surface of the substrate so as to at least partially cure the fluoropolymer composition to form a fluoroelastomer and to at least partially bond the fluoropolymer to the surface of the substrate to form a bonded structure having a fluoroelastomer at least partially bonded to the surface of the substrate. The substrate in the method may be one selected from the group consisting of ceramic, metals, metal alloys, semiconductors, and polymers, and the fluoropolymer may be a perfluoroelastomer, wherein the bonded structure has a perfluoroelastomer at least partially bonded to the surface of the substrate.

The method may also further comprises d) post-curing the bonded structure. If a perfluoroelastomer is used in the method, the perfluoroelastomer is preferably substantially cured and directly bonded to the surface of the substrate. In the method, step b) may further comprise providing a second substrate having a surface and step c) further comprise heat molding the curable fluoropolymer composition to the surface of the first substrate and to the surface of the second substrate to form a bonded structure, wherein the fluoropolymer is at least partially bonded to the surfaces of the first and the second substrates. In such a method, the bonded structure can form a laminated structure.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, the application contains drawings executed in color. Copies of this patent or patent application publication with color drawings will be provided by the Office upon request and payment of the necessary fee. It should be understood, however, that the invention is not limited to the precise arrangements and instrumentalities shown. In the drawings:

FIG. 1 is a photographic representation of a bonded structure having perfluoroelastomer bonded to sapphire formed according to an embodiment herein;

FIG. 2 is a further photographic representation of a structure having perfluoroelastomer bonded to sapphire as in FIG. 1;

FIG. 3 is a photographic representation of a bonded structure having a perfluoroelastomer bonded to alumina according to an embodiment herein;

FIG. 4 is a further photographic representation of bonded structures having a perfluoroelastomer bonded to alumina and a perfluoroelastomer bonded to sapphire according to embodiments herein;

FIG. 5 is a greatly enlarged photographic representation of cross-sectional view of a bonded structure having perfluoroelastomer bonded to silicon according to an embodiment herein;

FIG. 6 is a greatly enlarged photographic representation of bonded structures having silicone bonded to fluoroelastomer and to perfluoroelastomer according to embodiments herein;

FIG. 7 is a longitudinal cross-sectional side view of a standard slit valve door taken along line A-A of FIG. 9;

FIG. 8 is an enlarged portion of the slit valve door of FIG. 7;

FIG. 9 is a top plan view of a standard slit valve door having a seal bonded within a groove therein.

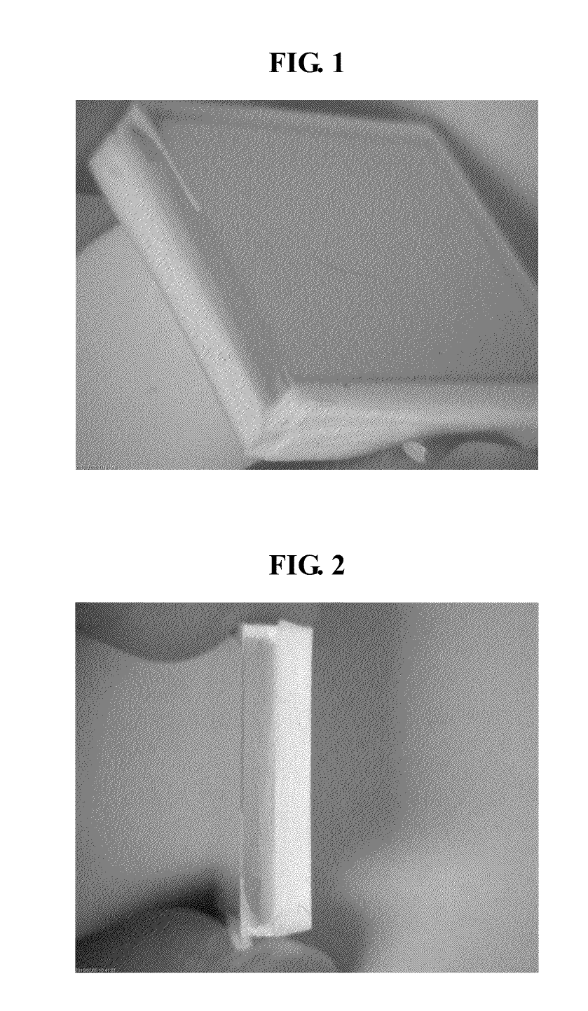

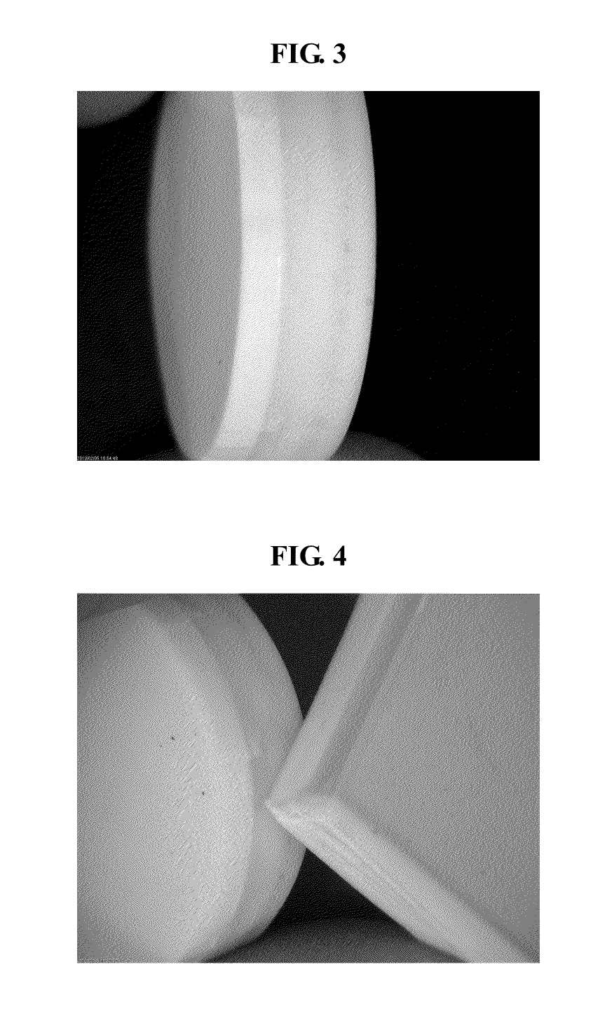

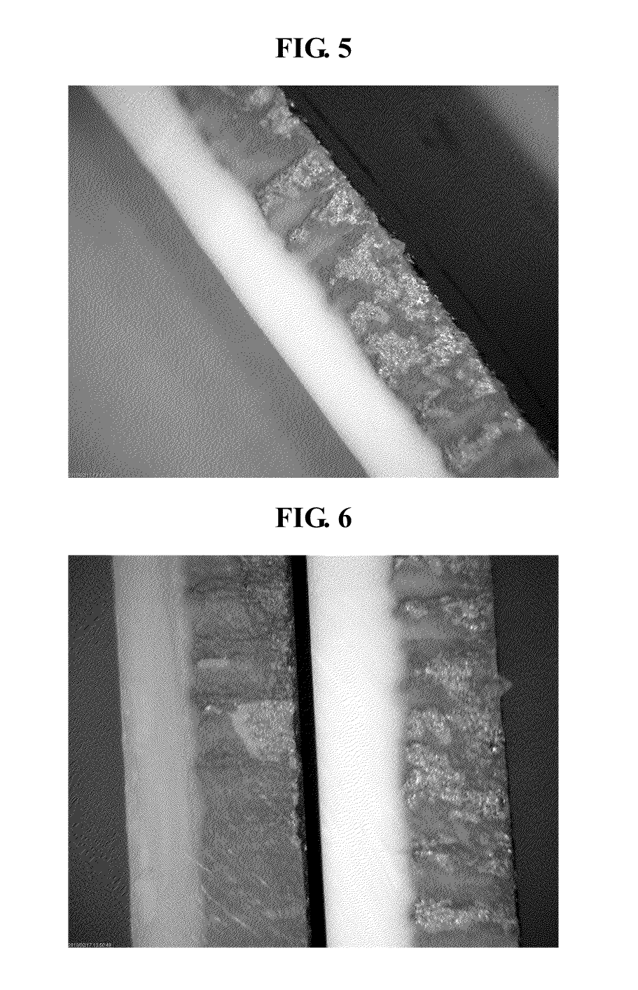

### DETAILED DESCRIPTION OF THE INVENTION

The invention herein provides a heavy-metal free compound that may be provided to an elastomer composition such that it is self-bonding to a substrate. In semiconductor applications many reaction chambers include interior walls, doors and other surfaces of, for example, anodized aluminum. Applicants evaluated compounds that, for example, without intending to be limiting, when perfluoroelastomer compositions function as a bonding enhancer to such surfaces without the need for external bonding agents. Such compounds, particularly if based on aluminum, enable the perfluoroelastomer composition to bond directly to such a substrate. In such example, even if etched, in service from the elastomer component give us particles which are not heavy metals, and will not form heavy particles, instead being easily removed from exhaust gases. After evaluating potential components, applicants determined a class of additives for fluoroelastomer compositions that enable self-bonding of the composition to a substrate.

The invention provides a new bonding composition and method for use in various high-temperature and/or harsh environments (such as semiconductor processing) to enable bonding of fluoroelastomers to substrates without the use of external bonding agents or primers, making them optional or unnecessary. This simplifies production processes by avoiding steps of brushing, drying and processing bonding agents and primers. It provides an easier, safer and more consistent process providing significant cost savings. Self-bonding compositions herein bond strongly to substrates thereby reducing potential delamination of parts. The resulting elastomer compositions when bonded to a surface provide excellent bonding strength by directly molding without use of additional bonding agents and good physical properties. The resulting compositions can provide bonded structures in which the elastomer component is benign enough for use in semiconductor applications, such structures can include parts used in processing equipment, laminates, and other structures having a surface with the elastomer compositions bonded thereto.

The invention includes a self-bonding curable fluoroelastomer composition, including a fluoropolymer composition. The fluoropolymer composition includes at least one curable fluoropolymer and a self-bonding additive compound which is at least one of aluminum acrylates, silicon acrylates, ammonia acrylates, and combinations thereof, used as a single component or in blends or combinations. The self-bonding curable fluoroelastomer composition is able to bond directly to a substrate.

The curable fluoropolymer in the composition may be any suitable fluoropolymer, including those preferred compositions which are used in harsher environments such as semiconductor processing. The curable fluoropolymers may be standard non-perfluorinated fluoropolymers (FKMs) as are known in the art or perfluoropolymers (FFKMs), which are also known in the art and are more common for use in semiconductor processing applications. Standard FKM polymers in accordance with elastomer nomenclature, typically have at least two monomers, one of which is fluorinated, and preferably all of which are fluorinated to some degree, with at least one curesite monomer for use in vulcanization. The at least two monomers generally include tetrafluoroethylene and vinylidene fluoride, but may include a wide variety of other monomers. The fluoroelastomer composition may also include at least one curing agent that is capable of undergoing a crosslinking reaction with a functional group in the curesite monomer(s).

A fluoropolymer may be formed by polymerizing two or more monomers, preferably one of which is fluorinated or perfluorinated, such as, for example tetrafluoroethylene (TFE), vinylidene fluoride (VF2), hexafluoropropylene (HFP), and at least one monomers which is a cure site monomer to permit curing, i.e. at least one fluoropolymeric curesite monomer. A fluoroelastomer composition as described herein may include any suitable standard curable fluoroelastomeric fluoropolymer(s) (FKM) capable of being cured to form a fluoroelastomer, and one or more curing agents as described herein. Examples of suitable curable FKM fluoropolymers include those sold under the trade name Tecnoflon® (P457, P459, P757, P959/30M) available from Solvay Solexis, S.p.A., Italy. Other suppliers of such materials are Daikin Industries, Japan; Dyneon, Minnesota; and E.I. DuPont de Nemours & Company, Inc., Delaware, among others. Such FKM polymers are not fully fluorinated on the backbone of the polymer. They may also include a variety of fillers as described herein, including nano-sized fluoropolymers.

A perfluoroelastomer, as used herein, and as defined in the art, may be any substantially cured elastomeric material derived by curing a perfluoropolymer (as defined herein) having at least one curesite monomer having a cross-linking functional group(s) to permit cure upon crosslinking reaction with one or more curing agent(s) or through radiation or other curing means. A perfluoropolymer, as used herein, is substantially fluorinated, and preferably completely fluorinated, with respect to the carbon atoms on the backbone of the perfluoropolymer. It will be understood that some residual hydrogen may be present in the perfluoropolymer in the functional group of the cure site monomer which would then reside in cross link sites in a cured elastomer due to the presence of hydrogen in some functional cross linking groups in certain FFKM perfluoropolymers. Perfluoropolymer for use in curable perfluoropolymer compositions herein, when cured form perfluoroelastomers.

The terms “uncured” or “curable”, refer to fluoropolymers or perfluoropolymers in compositions herein, which have not yet been subjected to crosslinking reactions in any substantial degree such that the material is not yet sufficiently cured for the intended application.

The curable fluorpolymer and perfluoropolymer compositions herein may optionally include additional such polymers in blend-like compositions or grafted/copolymerized compositions. Further, the polymer backbones may include a variety of curesite monomer(s) along the chain to provide one or more different functional groups for crosslinking. The compositions may also include curing agents and co-curing agents and/or accelerators to assist in the cross-linking reactions.

One or more curable fluoropolymers or perfluoroelastomers may be present in the compositions used herein. Such polymers are themselves formed by polymerizing or co-polymerizing one or more fluorinated monomers. In perfluoropolymers, one or more perfluorinated monomers are polymerized to form the polymer. Various techniques known in the art (direct polymerization, emulsion polymerization and/or free radical initiated polymerization, latex polymerization, etc.) can be used to form such polymers.

As used herein, a perfluoropolymer (which includes co-polymers and may have a number of monomers such as terpolymers, tetrapolymers and the like) is a polymeric composition that includes a curable perfluoropolymer formed by polymerizing two or more perfluorinated monomers, including at least one perfluorinated monomer that has at least one functional group to permit curing, i.e., at least one cure site monomer.

Curable perfluoropolymers can include two or more of various perfluorinated co-polymers of at least one of which is fluorine-containing ethylenically unsaturated monomer, such as TFE, a perfluorinated olefin, such as HFP, and a perfluoroalkylvinylether (PAVE) that include alkyl groups that are straight or branched and which include one or more ether linkages, such as perfluoro (methyl vinyl ether), perfluoro (ethyl vinyl ether), perfluoro (propyl vinyl ether) and similar compounds. Suitable examples of PAVEs include those described in, for example, U.S. Pat. No. 5,001,278 and WO 00/08076, of which the disclosure related to types of PAVEs are herein incorporated by reference. Additional suitable PAVEs are described in, for example, U.S. Pat. Nos. 5,696,189 and 4,983,697, of which the disclosure that is related to types of PAVEs are also herein incorporated by reference. Suitable perfluoropolymers may be those that meet the industry accepted definition of a perfluoroelastomer listed as an FFKM in ASTM V-1418-05 and, are may be, for example, terpolymers or tetrapolymers of TFE, PAVE, and have one or more perfluorinated cure site monomers that each incorporate a functional group to permit cross linking of the terpolymer, at least one of which is a cure site capable of being cured by the cure systems used in the practice of the invention.

Perfluoropolymers that may be used in the various embodiments of the invention include those that may be obtained from, for example, Daikin Industries, Inc.; Solvay Solexis; Dyneon; E.I. du Pont de Nemours, Inc.; W.L. Gore; Federal State Unitary Enterprise S.V.; Lebedev Institute of Synthetic Rubber in Russia; and Nippon Mektron in Japan.

In their uncured or curable state, the fluoroelastomer compositions of the invention preferably include at least one curing agent that is capable of undergoing a crosslinking reaction with one of the functional groups of the at least one cure site monomers present on the fluoropolymer(s). Any curing agent or combination of curing agents, co-curing agents and/or cure accelerators may be used. As examples, one may use functional group that reacts with a peroxide curing agent and/or co-curing agent in a peroxide cure system, or a curing agent that reacts with a cyano functional group in a cyano-functional cure system, depending on the end product and physical characteristics desired of the fluoroelastomer compositions herein. Regardless of the cure system or combination of systems employed, the fluoropolymer may contain at least one cure site monomer, although the presence of about 2 to about 20 cure site monomers (the same or different) may be used if desired.

When using a peroxide cure system, suitable curable perfluoropolymers include polymers of TFE, PAVES such as those described in U.S. Pat. No. 5,001,279 (incorporated herein in relevant part by reference), and cure site monomers having a fluorinated structure with a peroxide-curable functional group, such as, for example, halogenated alkyl and other derivatives, and partially- or fully-halogenated hydrocarbon groups.

If a cyano-curable system is used, suitable fluoropolymers include these as described in WO 00/08076, incorporated herein by reference, or other similar structures. Examples include tetrafluoroethylene, perfluoromethylvinyl ether, and primary and secondary cyano curable curesite monomers such as CF₂═CFO(CF₂)₃OCF(CF₃)CN, and/or CF₂═CFOCF₂CF(CF₃)O(CF₂)₂CN. Other suitable compounds may be those having a Mooney viscosity (measured at 100° C. on a TechPro® viscTECH TPD-1585 viscometer) of about 45 to about 95, and preferably of about 45 to about 65. Such materials may also be used in combination with other curing agents and/or with cure accelerators.

A variety of such fluoropolymers and perfluoropolymers are available, however, in accordance with a preferred embodiment herein, the fluoropolymer is a perfluoropolymer and the cure system is a peroxide cure system.

Any curing agent (curative) or combination of curing agents may be used. Curing agents for peroxide-based cure systems may be any peroxide curing agents and/or co-curing agents known to be developed in the art, such as organic and dialkyl peroxides or other peroxides capable of generating radicals by heating and engaging in a cross-linking reaction with the functional group(s) of a curesite monomer on the fluoropolymer chain. Exemplary dialkylperoxides include di-tertbutyl-peroxide, 2,5-dimethyl-2,5-di(tertbutylperoxy)hexane; dicumyl peroxide; dibenzoyl peroxide; ditertbutyl perbenzoate; and di-[1,3-dimethyl-3-(tertbutylperoxy)butyl]-carbonate. Other peroxidic systems are described, for example, in U.S. Pat. Nos. 4,530,971 and 5,153,272, incorporated in relevant part with respect to such curing agents by reference. Co-curing agents for such peroxide curing agents typically include isocyanurates and similar compounds that are polyunsaturated and work with the peroxide curing agent to provide a useful cure, such as, for example, triallyl cyanurate; triallyl isocyanurate; tri(methallyl)isocyanurate; tris(diallylamine)-s-triazine; triallyl phosphite; N,N-diallyl acrylamide; hexaallyl phosphoramide; N,N,N′,N′-tetraalkyl tetraphthalamide; N,N,N,N′-tetraallyl malonamide; trivinyl isocyanurate; 2,4,6-trivinyl methyltrisiloxane; and tri(5-norbornene-2-methylene)cyanurate. The most preferred is and well known in the art is triallyl isocyanurate (TAIC) which is sold under the trade name DIAK®, e.g. DIAK® #7 and TAIC®.

For the cyano-based systems, suitable primary curing agents include monoamidines and monoamidoximes as described as U.S. Patent Publication No. US-2004-0214956-A1, the disclosure of which is incorporated herein by reference in relevant part.

The amidine-based and amidoxime-based materials include monoamidines and monoamidoximes of the following formula (I) described further below. Preferred monoamidines and monoamidoximes may be represented by formula (I):

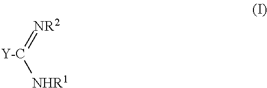

wherein Y may be a substituted alkyl, alkoxy, aryl, aralkyl or aralkoxy group or an unsubstituted or substituted fully or partially halogenated alkyl, alkoxy, aryl, aralkyl or aralkoxy group having about 1 to about 22 carbon atoms. Y may also be a perfluoroalkyl, perfluoroalkoxy, perfluoroaryl, perfluoroaralkyl or perfluoroaralkoxy group of about 1 to about 22 carbon atoms or a perfluoroalkyl or perfluoroalkoxy group of about 1 to 12 carbon atoms, or about 1 to about 9 carbon atoms; and R¹ may be hydrogen or substituted or unsubstituted lower alkyl or alkoxy groups of about 1 to about 6 carbon atoms, oxygen (such that NHR¹ is a NOH group) or an amino group. R² may be independent from any of the groups listed above for R¹ or a hydroxyl. Substituted groups for Y, R¹ or R² include, without limitation, halogenated alkyl, perhalogenated alkyl, halogenated alkoxy, perhalogenated alkoxy, thio, amine, imine, amide, imide, halogen, carboxyl, sulfonyl, hydroxyl, and the like. If R¹ and R² are both selected as oxygen and hydroxyl, such that there are two NOH groups on the compound (a dioxime can be used), and in that case, formula (I) can be found modified to accommodate a dioxime formula in which the carbon atom and the Y group together form an intervening aromatic ring and in which the NOH groups are located ortho-, para- or meta- to one another on the ring, such as with p-benzoquinonedioxime.

In formula (I), R² may be hydroxyl, hydrogen or substituted or unsubstituted alkyl or alkoxy groups of about 1 to about 6 carbon atoms, more preferably hydroxyl or hydrogen. R¹ may be hydrogen, oxygen, amino or substituted or unsubstituted lower alkyl of about 1 to about 6 carbon atoms while R² is hydrogen or hydroxyl. R¹ and R² may both be hydrogen. Y may be a perfluoroalkyl, perfluoroalkoxy, substituted or unsubstituted aryl groups and substituted or unsubstituted halogenated aryl groups having the chain lengths as noted above, particularly preferred are when R¹ and R² are both hydrogen and Y is CF₃(CF₂)₂—i.e. when the compound is heptafluorobutyrlamidine or a similar amidoxime compound.

Exemplary monoamidine-based and monoamidoxime-based curing agents include perfluoroalkylamidines, arylamidines, perfluoroalkylamidoximes, arylamidoximes and perfluoroalkylamidrazones. Other examples include perfluorooctanamidine, heptafluorobutyrylamidine, trifluoromethylbenzamidoxime, and trifluoromethoxybenzamidoxime, with heptafluorobutyrlamidine being most preferred.

Other curing agents can include bisphenyl-based curing agents and their derivatives, such as bisaminophenol, tetraphenyltin, triazine, peroxide-based curing systems (e.g. organic peroxide such as dialkyl peroxides), or combinations thereof. Other suitable curing agents include oganometallic compounds and the hydroxides, especially organotin compounds, including ally-, propargyl-, triphenyl- and allenyl tin, curing agents containing amino groups such as diamines and diamine carbamates, such as N,N′-dicinnamylidene-1,6-hexanediamine, trimethylenediamine, cinnamylidene, trimethylenediamine, cinnamylidene ethylenediamine, and cinnamylidene hexamethylenediamine, hexamethylenediamine carbamate, bis(4-aminocyclohexly)methane carbamate, 1,3-diaminopropane monocarbamate, ethylenediamine carbamate, trimethylenediamine carbamate, bisaminothiophenols, bisamidoximes, and bisamidrazones. Most preferably a peroxide cure system (including any necessary co-agents) is used.

Any curing agent(s) may be used alone, in combination, or with secondary curing agents. Thus, the curing system does not require, but may also optionally include, a variety of secondary curing agents, such as bisphenyl-based curing agents and their derivatives, tetrapheyltin, triazine, peroxide-based curing systems (e.g., organic peroxides such as dialkyl peroxides) if not used as a primary agent or if used in a combination or peroxides, or combinations of these systems. Other suitable secondary curing agents include oganometallic compounds and the hydroxides thereof, especially organotin compounds, including ally-, propargyl-, triphenyl- and allenyl tin, curing agents containing amino groups such as diamines and diamines carbamates, such as N,N′ dicinnamylidene-1,6-hexanediamine, trimethylenediamine, cinnamylidene, trimethylenediamine, cinnamylidene ethylenediamine, and cinnamylidene hexamethylenediamine, hexamethylenediamine carbamate, bis(4-aminocyclohexly)methane carbamate, 1,3-diaminopropane monocarbamate, ethylenediamine carbamate, trimethylenediamine carbamate, and bisaminothiophenols.

At least one of a curing agent, co-curing agent and/or a cure accelerator may also be included depending on the cure system adopted. The composition may also include least two curable fluoropolymers or perfluoropolymers, such as, for example, in a fluoropolymeric or perfluoropolymeric blend.

Examples of optional fillers which may be used in the FKM compositions herein including, for example, without limitation, fluoropolymer powders, fluoropolymer micropowders, core-shell fluorpolymer fillers, fluoropolymer nanopowders, cross-linkable fluoroplastic fillers, carbon black, fluorographite, silica, silicates, glass fiber, glass spheres, fiberglass, calcium sulfate, asbestos, boron fibers, ceramic fibers, aluminum hydroxide, barium sulfate, calcium carbonate, magnesium carbonate, alumina, aluminum nitride, borax, perlite, zinc terephthalate, silicon carbide platelets, silicon carbide whiskers, wollastonite, calcium terephthalate, fullerene tubes, Hectorite, talc, mica, carbon nanotubes. Such fillers may be present in the overall composition in amounts of up to about 50 parts per hundred per 100 parts base fluoropolymer, preferably up to about 20 parts per hundred, wherein the 100 parts base fluoropolymer would include all such base fluoropolymer(s) in the composition.

In FFKM compositions, for use, for example in semiconductor applications, preferred optional filler(s) may optionally be fluoropolymer powders, fluoropolymer micropowders, core-shell fluorpolymer fillers, fluoropolymer nanopowders, cross-linkable fluoroplastic fillers, carbon black, fluorographite, silica, silicates, barium sulfate, calcium carbonate, magnesium carbonate, alumina, aluminum nitride, and carbon nanotubes. Silica, carbon black (such as a high purity thermal carbon black), fluoropolymer micropowders, nanopowders and cross-linkable fluoroplastics being most preferred. Preferably no heavy metal additives are provided in compositions herein used in semiconductor processing applications.

As noted above, the self-bonding fluoroelastomer composition of the above-noted embodiment is preferably able to bond directly to a substrate. Such substrates may include materials that are substrates for various structures and/or laminates, some of which may be used inside a semiconductor processing chamber, or may be substrates actually used to form parts of processing equipment, for example, in semiconductor processing equipment (chamber walls, processing doors, gates, etc.). Substrates may include materials such as, for example, ceramic, metals, metal alloys, semiconductors, and polymers. Preferred substrates in semiconductor processing and other areas include ceramics such as alumina, sapphire, and other similar materials, semiconducting metals and metalloids, such as boron, silicon, germanium, arsenic, antimony, tellurium, polonium, yttria and yttrium-containing compounds, and metallic surfaces used in such applications for processing chambers, doors and the like such as anodized aluminum, aluminum and stainless steel, and other materials used in such equipment such as polytetrafluoroethylene (PTFE) seal, o-ring and gasket shielding materials.

For other end applications, it is possible to use the self-bonding compositions herein to bond to other surfaces such as metals, including, for example, beryllium, copper, silver, aluminum, chromium, titanium, nickel, zinc and/or metal alloys or other metal mixtures, such as, for example, titanium alloys and copper alloys, beryllium-copper alloys, nickel-silver alloys, nickel-titanium alloys, chromium alloys, brass, and stainless steel. Titanium alloys and nickel alloys, such as the austenitic nickel-based superalloys sold under the tradename INCONEL® by Special Metal Corporation, New Hartford, N.Y., United States of America may be suitable as well. Other suitable polymeric substrates include PTFE, polyaryl ether ketones (PAEK) polymers, such as, for example, polyetheretherketone (PEEK), polyetherketoneketone (PEKK), polyetherketone etherketone ketone (PEKEKK), PEEK blended with thermoplastic polyimide (PEEK+TP-PI), and polyetherketone (PEK).

The bonding compound(s) useful as additives in the compositions herein include aluminum acrylates, silicon acrylates, ammonia acrylates, and combinations thereof. The acrylate portion of such aluminum acrylates, silicon acrylates and ammonia acrylates may be an acrylate, an alkyl acrylate, or a perfluorinated alkyl acrylate. It is preferred that the acrylate in the compounds is one of a monoacrylate, a diacrylate or a triacrylate, however, chain polymeric acrylates may also be used, provided the chain length does not interfere with incorporation of the compound into the curable FKM or FFKM. The acrylate is preferably a mono-, di-, tri-acrylate and the like.

Most preferred of these compounds is aluminum acrylate (also known as aluminum triacrylate, acrylic acid aluminum salt, and triacrylic acid aluminum salt; CAS 315743-20-1 having a molecular weight of about 243.17) is preferred and may be a commercial compound or compound synthesized having chemical formula Al(C═CHCOO)₃. Exemplary commercial compounds available for such use are aluminum triacrylate, sold as Sartomer Product PRO-4302, available from Sartomer Company Inc. of Exton Pa., and are available from Alfa Aesar as Product 42003.

The above-discussed fluoroelastomeric composition may contain any or all of the various components discussed above in varied proportions, ratios, and permutations. Individuals of skill in the art will recognize such ingredients and relative ratios may be altered and varied depending on the desired characteristics of the end product, which in turn is informed by the application into which the bonded component is to be used.

Preferably, based on 100 parts of the base fluoropolymer(s), the aluminum acrylates, silicon acrylates and/or ammonia acrylates used as a bonding compound(s) in the composition are provided in amount of about 1 to about 20, preferably about 1 to about 15, more preferably about 1 to about 10, and most preferably about 1 to about 5 parts per hundred to the composition. However, it should be understood that more of less of the bonding compounds noted herein may be provided so long as sufficient self-bonding properties are achieved and preferably physical and other elastomeric properties are not materially affected.

Curing agent(s) are preferably used and may be present in the amount necessary to provide adequate cure for the given functional group(s), for example, in an amount of about 0.1 to about 5 parts per 100 parts base fluoropolymer(s), preferably about 0.2 to about 3 parts per hundred or about 2 to about 4 parts per hundred curing agent(s), preferably such curing agents are part of a peroxide curing system as noted elsewhere herein. In the case of a peroxide curing agents, co-curing agents, such as TAIL, are preferably added in amounts of about 1 parts to about 10 parts per hundred based on 100 parts base fluoropolymers, and about 1 to about 5 parts per hundred based on 100 parts of the base fluoropolymer(s) herein. Optionally, as noted elsewhere herein, accelerators or co-curing agents can be used in preferred amounts, for example, of 0 to about 6 parts per hundred based on 100 parts by weight of the base fluoropolymer(s). When used with peroxide curing agents can improve curing speed and degree of cross-linking.

In bonding, the fluoroelastomer composition is “self-bonding” in that use of a bonding agent is optional and not required, and the resulting composition while curing forms a direct bond with a surface of a substrate during the curing process and/or upon application of heat and pressure. Typical temperatures for curing/bonding for FKMs and FFKMs are in the range, for example, of about 100° C. to about 180° C., and preferably about 149° C. to about 154° C., with curing/bonding times of about 5 to about 10 minutes, preferably about 8 to about 10 minutes. However, one skilled in the art would understand from this disclosure that the curing times and temperatures will vary depending on the initial fluoroelastomer and crosslinking system chosen.

Pressure to be applied may be from various sources, such as a hot press mold and can range from about 200 psi to 3000 psi, depending again on the resulting structure to be formed and the materials being used therein.

The invention includes methods of bonding the fluoroelastomer composition to the surface of the substrate by contacting a curable FKM or FFKM composition (as described above) to the substrate and curing it via any curing means known or developed in the art. Most preferably, an FKM or FFKM composition is prepared by blending on a typical FKM or FFKM mixer or blending apparatus, and combining any additive, curing agents and the self-bonding compound(s) noted above. The resulting combined uncured composition (or gum) is then preferably formed into a preform wherein, the preform may be formed by any means, including cutting, clicking, extruding, molding, etc. The preform may be partially cured (e.g., some crosslinking may have occurred, but not to the desired extent). Preferably, however, the preform is contacted to the surface of the substrate and cured in situ while molding into a shape within a bonded structure. For example, an extruded rope can be situated in a groove in a bonded gate door and cured while being molded into a seal in the groove (in situ). Preforms can be placed on the surface in either in a groove, hole, or other surface feature or directly on a flat, curved or pre-configured surface for molding. Preforms can be made into shapes for which such FKMs and FFKMs are typically used, including o-rings, gaskets, seals, coatings, laminates and the like. In the case of a gate door, for example, in semiconductor processing equipment, a perform extrudate may be shaped to fit within a prepared groove in the door surface and the molding process will enable the fluoroelastomer composition to bond to the surface in the groove, without putting adhesives or bonding agents on the pre-form or the surface prior to molding.

Other preforms include, for example, an extruded or shaped sheet of the elastomer compositions herein, which can be placed on a surface, and optionally between two surfaces in a sandwich-like configuration and then heat molded to form coated surfaces or laminated structures.

The self-curing composition then at least partially bonds due to application of heat and/or pressure to the surface of the substrate while elastomer cross-linking proceeds and the elastomer forms by at least partially curing. The bonds thus continue to fouls between the composition and the substrate. Additional curing can continue and/or appropriate post-curing depending on the elastomer and the cure cycle used until substantially complete and/or complete curing and bonding are achieved.

Curing may be by any method known or to be developed in the art including heat cure, cure by application of high energy, heat cure, press cure, steam cure, a pressure cure, an e-beam cure or cure by any combination of means, etc. Post-cure treatments may also be applied, if desired for complete cure. As noted above, temperatures such as about 100° C. to about 180° C., and preferably about 120° C. to about 160° C. may be used for varying times as noted with respect to the curing/bonding conditions above, and again, can be varied depending on the FKM or FFKM system chosen, the curing system chosen and the end application. Optional post-curing may be applied, and would preferably be used when sufficient curing and/or bonding does not occur in the primary bonding/curing cycle.

A method of bonding a FKM or FFKM to a substrate is also described herein. In preparing such a curable FKM or FFKM composition, as noted above, the components are combined by blending, mixing and the like, as noted above. A substrate having a surface, such as the substrates described above is then provided and the curable composition is heat molded on the surface of the substrate with the curable FKM or FFKM composition thus bonding to the surface of the substrate, so as to at least partially cure the FKM or FFKM composition to form a fluoroelastomer or perfluoroelastomer and to at least partially bond the FKM or FFKM composition as it cures to the surface of the substrate thereby forming a bonded structure having an at least partially cured fluoroelastomer or perfluoroelastomer at least partially bonded to the surface of the substrate, and in the case of laminated structures, bonded two a first and a second surface, wherein the two surfaces may be the same material or different materials. Curing and bonding can continue until an adequate level of crosslinking and bonding is achieved, and the structure is preferably substantially completely, or completely, crosslinked and bonded.

The self-bonding perfluoroelastomer composition of the above-noted embodiment is preferably able to bond directly to a substrate.

The resulting bonded structures have an FFKM or FKM elastomer bonded to the surface of the substrate (or to a surface on a first substrate and a second substrate). The fluoroelastomer or perfluoroelastomer thus bonded to the substrate(s) preferably includes a bonding compound as set forth herein, such as the aluminum acrylates, silicon acrylates, and ammonia acrylates described above. The substrates within such structures are also described above. Bonded structures may be, for example, a structure selected from the group consisting of a laminated structure, a gate valve, a semiconductor chamber door, and a bonded slit valve.

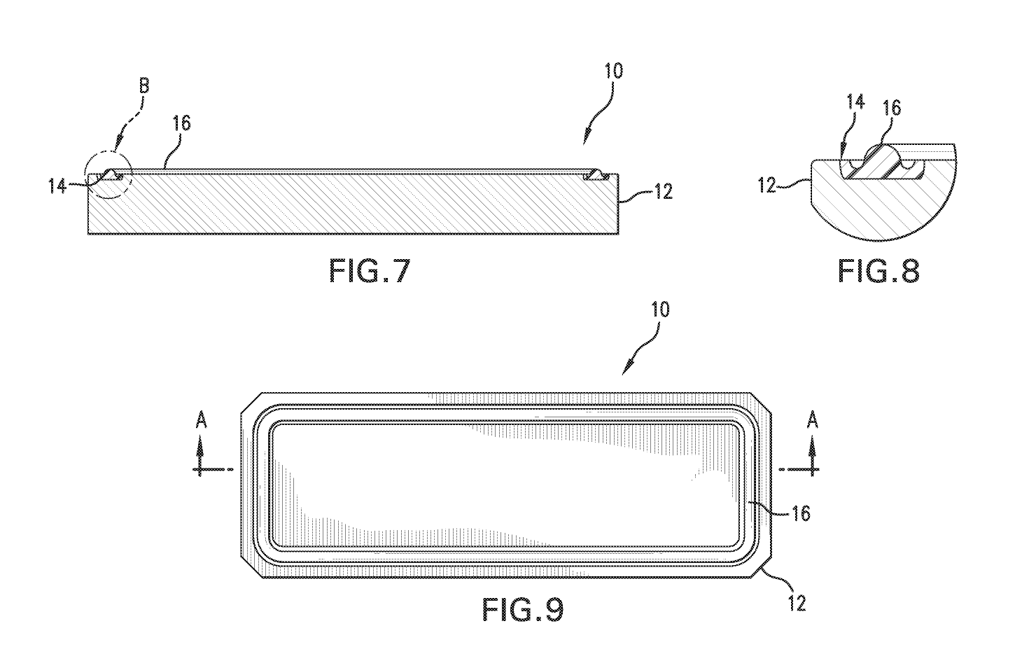

An example of a typical such substrate in the form of a slit valve can be seen in FIGS. 7 and 9. A slit valve door 10 has a metallic door 12 and a seal 16 that fits within a groove in the surface of the door 12. The seal is bonded to the surface 14 at the point shown in FIG. 8. In the applicants invention, the seal 16 is formed of a self-bonding composition as described herein and bonds at surface 14 to the door 12 in a direct bond. While an optional bonding agent can be provided, it is preferred that the compositions be directly bonded to the door.

The invention will now be described with respect to the following non-limiting example(s).

### Example 1

In this example various commercial perfluoropolymers were cured and bonded using existing bonding agents used in the art to a surface and tested as control samples A (using DP-1520 a formulation based on a commercial bonding agent), and B and C (each using TruBond® 101 bonding agents). A further control D was prepared by simply direct molding a standard FFKM to a surface without a bonding agent. Control sample E was prepared using a prior art self-bonding composition noted in the background herein (including SR633® from Sartomer which includes a heavy metal component) that was bonded and molded in situ to a surface. The same perfluoropolymers were made into compositions (Samples 1-5) including a bonding compound as described herein (Pro-4302 from Sartomer) which is aluminum acrylate, and bonded by direct molding to a surface and tested.

Compound controls A, B and C as well as the Experimental Samples 1-5 were formed using as the base polymer the peroxide-curable FFKM material commercially sold by Daikin Industries, Japan, under the name GA-1058. However, the amounts of components provided were varied, including the amounts of standard additives (silica Aerosil® R972 or Thermal carbon black, Thermax® N990) and the bonding agents or compounds as noted above. Peroxide curing agent and co-curing agent (Luperox® 101 and Diak® No. 7, respectively) were also provided in the amounts noted in Table 1 below.

In the Examples herein, bonding of the FFKM samples was achieved by directly molding the FFKM compositions onto a metallic substrate under a pressure of about 2,000 psi, and a pressing temperature of about 149° C. for about 8 minutes. The molding pressure was varied to about 320 psi when directly bonding the FFKM sample to a brittle ceramic or silicon substrate. All samples were subjected to post-curing processing in a stepwise manner up to 180° C. in 7 hours. The bond formed by the inventive samples showed a bonding force at room temperature (about 20° C.) of at least about 800 pounds load (e.g., load at failure) to about 1800 lbs for compound additive amounts of greater than 0 to about 5 parts per 100 parts base perfluorpolymer, however, more or less strength can be achieved by varying the base formulation and the amount of bonding compound.

TABLE 1

| | Sample No. | | | | | | | | | |
|---|---|---|---|---|---|---|---|---|---|---|
| | A | B | C | 1 | 2 | 3 | 4 | D | E | 5 |
| Peroxide- | 100 | 100 | 100 | 100 | 100 | 100 | 100 | 100 | 100 | 100 |
| curable FFKM | | | | | | | | | | |
| Aerosil R972 | 8 | 8 | 8 | 8 | 8 | 8 | 8 | | | |
| N990 | | | | | | | | 8 | 8 | 8 |
| Diak No. 7 | 3 | 3 | 3 | 3 | 3 | 3 | 3 | 3 | 3 | 3 |
| Luperox 101 | 1.5 | 1.5 | 1.5 | 1.5 | 1.5 | 1.5 | 1.5 | 1.5 | 1.5 | 1.5 |
| Sartomer SR | | | 2 | | | | | | | |
| 633 | | | | | | | | | | |
| Sartomer Pro- | | | | 2 | 4 | 1 | 5 | | | 5 |
| 4302 | | | | | | | | | | |
| Total | 112.5 | 112.5 | 114.5 | 114.5 | 116.5 | 113.5 | 117.5 | 112.5 | 112.5 | 117.5 |
| | Control | Control | Control | Pro4302 | Pro4302 | Pro4302 | Pro4302 | Control | Control | Pro4302 |

Sample/Bonding Force (lb, Al Bonding insert)

| | | | | | | | | | | |
|---|---|---|---|---|---|---|---|---|---|---|
| Bonding Agent | DP1520 | TruBond | Direct | Direct | Direct | Direct | Direct | Direct | TruBond | Direct |
| or Compound | | 101 | Mold | Mold | Mold | Mold | Mold | Mold | 101 | Mold |
| Trial 1 | 709 | 556 | 1506 | 1291 | 1448 | 1142 | 1641 | 420 | 453 | 1256 |
| Trial 2 | 733 | 609 | 1344 | 1283 | 1421 | 1081 | 1507 | 427 | 572 | 1240 |
| Average | 721 | 583 | 1431 | 1287 | 1435 | 1112 | 1574 | 424 | 513 | 1248 |
| Failure Mode | No | No | Rubber | No rubber | No rubber | | One | | | |
| | rubber | rubber | failure | failure, | failure, | | piece | | | |
| | failure, | failure, | | interface | whitish | | started | | | |
| | brownish | brownish | | whitish | color | | to tear | | | |
| | interface | interface | | color | interface, | | | | | |
| | | | | | one piece | | | | | |
| | | | | | started to | | | | | |
| | | | | | tear | | | | | |

Some of the samples that remained after bond strength testing were also tested for other various common properties and that data is shown in Tables 2, 3 and 4 below.

Sample 4 herein was also tested for peel strength of the cured FFKM elastomer to the surface of the substrate using ASTM D6862-04. An Instron 3365 was used with a crosshead speed of 10 in/minute, at a temperature of 77° F. and a humidity of 22%. The specimens were run for 8 min. at 300° F., 7¼ step at 356° F. air. The results were measured in lb_{f}/in. A first sample showed 8.3 lb_{f}/in and a second showed 9.37 lb_{f}/in, with an average of 8.84 and were tested until peeling occurred.

As demonstrated, samples according to the invention provide high bonding strength for use in difficult environments, while providing good physical properties and acting as self-bonding, easy to mold compositions that do not readily delaminate.

TABLE 2

| Sample | | | | | | | |
|---|---|---|---|---|---|---|---|
| Cont. A | Cont. C | 1 | 2 | 3 | 4 | Cont. D | 5 |

RPA data

| | | | | | | | | |
|---|---|---|---|---|---|---|---|---|
| S′@2 Hz | 4.292 | 4.914 | 5.479 | 6.32 | 5.018 | 6.655 | 3.164 | 4.684 |
| Tandelta@2 Hz | 0.691 | 0.711 | 0.634 | 0.622 | 0.64 | 0.629 | 0.746 | 0.66 |
| ML, in-lb | 0.184 | 0.198 | 0.286 | 0.334 | 0.298 | 0.366 | 0.121 | 0.248 |
| MH, in-lb | 11.14 | 13.51 | 12.68 | 13.93 | 11.8 | 14.25 | 10.19 | 13.26 |
| T90, min | 4.09 | 4.14 | 3.6 | 3.79 | 3.44 | 3.64 | 4.12 | 4.38 |
| T2, min | 1.29 | 1.51 | 1.27 | 1.31 | 1.23 | 1.3 | 1.51 | 1.57 |
| S′@5.02% | 20.77 | 24.93 | 23.25 | 25.24 | 21.63 | 25.47 | 18.99 | 24.72 |
| dNm | | | | | | | | |
| Tandelta@ | 0.008 | 0.006 | 0.02 | 0.004 | 0.005 | 0.009 | 0.005 | 0.004 |
| 5.02% dNm | | | | | | | | |

TABLE 3

| Sample | | | | | | | |
|---|---|---|---|---|---|---|---|
| Cont. | Cont. | | | | | | |
| A | C | 1 | 2 | 3 | 4 | Cont. D | 5 |

MDR (300 F/8 Mins)

| | | | | | | | | |
|---|---|---|---|---|---|---|---|---|
| S′Max − | 28.84 | 33 | 31.86 | 33.98 | 30.26 | 34.21 | 21.67 | 28.03 |
| S″min | | | | | | | | |
| Lb-in | | | | | | | | |
| S′Max, lb-in | 29.33 | 33.5 | 32.58 | 34.85 | 30.95 | 35.13 | 21.95 | 28.56 |
| S′Min, lb-in | 0.49 | 0.5 | 0.72 | 0.87 | 0.69 | 0.92 | 0.28 | 0.53 |
| Tc10, min | 0.76 | 1.02 | 0.77 | 0.81 | 0.68 | 0.8 | 0.95 | 1.03 |
| Tc50, min | 1.39 | 1.57 | 1.24 | 1.28 | 1.13 | 1.25 | 1.5 | 1.64 |
| Tc90, min | 3.66 | 3.4 | 2.97 | 3.01 | 2.91 | 3.00 | 3.45 | 3.66 |
| Ts1, min | 0.65 | 0.86 | 0.65 | 0.67 | 0.58 | 0.67 | 0.85 | 0.88 |
| Ts2, min | 0.71 | 0.94 | 0.72 | 0.74 | 0.64 | 0.74 | 0.94 | 0.97 |

TABLE 4

| Sample | | | | | | | |
|---|---|---|---|---|---|---|---|
| Cont. A | Cont. C | 1 | 2 | 3 | 4 | Cont. D | 5 |

Physical Properties

| | | | | | | | | |
|---|---|---|---|---|---|---|---|---|
| Hardness “A” | 76 | 78 | 78 | 79 | 77 | 80 | 70 | 75 |
| Hardness “M” | | | | | 85 | 87 | 71 | 84 |
| Specific | 2.00 | 2.00 | 2.00 | 1.99 | 1.995 | 1.986 | 1.982 | 1.968 |
| Gravity | | | | | | | | |
| Tensile | 2145 | 1974 | 2042 | 2318 | 1944 | 2341 | 1352 | 1874 |
| Strength (psi) | | | | | | | | |
| Elongation (%) | 157 | 120 | 123 | 120 | 128 | 112 | 153 | 123 |
| 100% Modulus | 1106 | 1507 | 1522 | 1801 | 1384 | 1973 | 607 | 1321 |
| 50% Modulus | 449 | 555 | 596 | 692 | 541 | 717 | 245 | 443 |

Compression Set

| | | | | | | | | |
|---|---|---|---|---|---|---|---|---|
| 400° F./70 h/25% | 33.09 | 26.09 | 36.23 | 31.88 | 35.29 | 35.29 | 52.94 | 55.88 |
| 450° F./70 h/25% | 57.55 | 63.77 | 68.12 | 63.77 | 70.59 | 75.47 | 91.18 | 79.41 |

### Example 2

In this Example, an FKM available commercially as Tecnoflon® P959 from Solvay Solexis was used as a base curable fluoropolymer. Various additives were used in the formulations, including silica and nano-clay filler (Aerosil® R-972 and Nanomer 1.30 PS, respectively). Each of the formulations was peroxide curable using a peroxide curing agent (Luperox® 101) and a co-curing agent (Diak® #7) in accordance with the amounts set forth in Table 5. Control Samples with different filler systems were provided for comparison including the use of no bonding compound (Controls F, H, and I), a prior art bonding compound (Sartomer® SR633) (Control G). Controls F, H, and I were tested using an externally applied commercial bonding agent (TruBond 101). Control G was tested with no external bonding agent and with the TruBond 101 external bonding agent. The inventive examples 6 and 7 were tested both with and without an external bonding agent to show the effect of the composition on bonding force required to pull the bond to failure to show that the strength of the bond was actually higher when bonded directly to the surface than when bonded through a commercial bonding agent.

In the examples disclosed herein, bonding an FKM sample was achieved by directly bonding it to a metal substrate surface under a pressure of about 2,000 psi and a press temperature of about 154° C. for about 10 minutes. The molding pressure of about 320 psi was used to directly bond to brittle ceramic or silicon substrates. All samples were subject to post-curing in a stepwise manner to 232° C. at which the sample was held for 2 hours.

The various resulting bonding results are shown in Table 5 and physical properties are and other elastomer properties are set forth in Tables 6-8.

The bond had a bonding force at room temperature of at least about 700 pounds load (e.g., load at failure) to about 3,000 pounds for compound additive amounts of greater than zero to about 5 parts per 100 parts base fluoroelastomer. This bond durability is measured using the standard test method for rubber property adhesion to rigid substrates, ASTM D 429-03 (2006), Method A, the contents of which are incorporated herein by reference. The method includes molding a 3.2+/−1 mm cylinder of test rubber between two 1250+/−5 mm² metal or rigid substrate plates. The plates are pulled at a uniform rate of 40+/−0.04 mm/s. The load (in pounds) at which the bond fails is the “pounds load” unit indicating the strength of the bond.

As demonstrated, samples according to the invention provide high bonding strength for use in difficult environments, while providing good physical properties and acting as self-bonding, easy to mold compositions that do not readily delaminate.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

TABLE 5

| | Sample No. | | | | | |
|---|---|---|---|---|---|---|
| | Control F | Control G | 6 | Control H | Control I | 7 |
| Peroxide- | 100 | 100 | 100 | 100 | 100 | 100 |
| curable FKM | | | | | | |
| Aerosil R972 | 13.00 | 13.00 | 13.00 | | | |
| Nanomer 1.3 PS | | | | 4.00 | 8.00 | 8.00 |
| Diak No. 7 | 3.5 | 3.5 | 3.5 | 3.5 | 3.5 | 3.5 |
| Luperox 101 | 1.5 | 1.5 | 1.5 | 1.5 | 1.5 | 1.5 |
| Sartomer | | 2.00 | | | | |
| SR 633 | | | | | | |
| Sartomer | | | 2.00 | | | 2.00 |
| Pro-4302 | | | | | | |
| Total | 118 | 120 | 120 | 109 | 113 | 115 |
| | Control | Control | Pro4302 | Control | Control | Pro4302 |

Sample/Bonding Force (lb, Al Bonding insert)

| | | | | | | |
|---|---|---|---|---|---|---|
| Bonding Agent | TruBond | TruBond | TruBond | TruBond | TruBond | TruBond |
| or Compound | 101 | 101 | 101 | 101 | 101 | 101 |
| Trial 1 | 2306 | 2850 | 2742 | 942 | 1463 | 1478 |
| Trial 2 | 2164 | 2805 | 2757 | 982 | 1272 | 1461 |
| Average | 2235 | 2828 | 2750 | 962 | 1368 | 1470 |
| Failure Mode | | | | Slight tear | Slight tear | Slight tear |
| Bonding Agent | | None | None | | | None |
| Trial 1 | | 2969 | 2919 | | | 1581 |
| Trial 2 | | 2881 | 2941 | | | 1579 |
| Average | | 2925 | 2930 | | | 1580 |
| Failure Mode | | | | | | Rubber Tear |

TABLE 6

| Sample | | | | | |
|---|---|---|---|---|---|
| Control | Control | | Control | Control | |
| F | G | 6 | H | I | 7 |

RPA data

| | | | | | | |
|---|---|---|---|---|---|---|
| S′@2 Hz | 3.260 | 3.360 | 3.980 | 2.283 | 3.085 | 3.502 |
| Tandelta@2 Hz | 0.517 | 0.553 | 0.501 | 0.517 | 0.487 | 0.493 |
| ML, in-lb | 0.499 | 0.508 | 0.628 | 0.377 | 0.583 | 0.629 |
| MH, in-lb | 13.54 | 17.89 | 15.14 | 9.414 | 13.72 | 15.36 |
| T90, min | 5.16 | 5.50 | 6.21 | 4.16 | 5.44 | 5.77 |
| T2, min | 1.52 | 1.53 | 1.60 | 1.52 | 1.41 | 1.52 |
| S′@5.02% | 22.12 | 28.4 | 24.85 | 16.12 | 22.09 | 24.43 |
| dNm | | | | | | |
| Tandelta@ | 0.04 | 0.061 | 0.034 | 0.028 | 0.062 | 0.06 |
| 5.02% dNm | | | | | | |

TABLE 7

| Sample | | | | | |
|---|---|---|---|---|---|
| Control | Control | | | | |
| F | G | 6 | Control H | Control I | 7 |

MDR (300 F/8 Mins)

| | | | | | | |
|---|---|---|---|---|---|---|
| S′Max − S″min | 28.55 | 40.25 | 32.79 | 19.84 | 27.83 | 30.9 |
| Lb-in | | | | | | |
| S′Max, lb-in | 29.68 | 41.4 | 34.18 | 20.73 | 29.09 | 32.23 |
| S′Min, lb-in | 1.13 | 1.15 | 1.42 | 0.89 | 1.26 | 1.33 |
| Tc10, min | 0.96 | 1.05 | 1.0 | 0.89 | 0.87 | 1.01 |
| Tc50, min | 2.02 | 2.22 | 2.30 | 1.59 | 1.66 | 1.96 |
| Tc90, min | 4.66 | 4.72 | 5.90 | 3.3 | 4.75 | 5.17 |
| Ts1, min | 0.77 | 0.77 | 0.75 | 0.77 | 0.69 | 0.77 |
| Ts2, min | 0.88 | 0.87 | 0.88 | 0.89 | 0.8 | 0.9 |

TABLE 8

| Sample | | | | | | |
|---|---|---|---|---|---|---|
| Target | Control F | Control G | 6 | Control H | Control I | 7 |

Physical Properties

| | | | | | | | |
|---|---|---|---|---|---|---|---|
| Hardness “A” | 75 | 75 | 79 | 77 | 72 | 88 | 87 |
| Hardness “M” | n/a | 81 | 83 | 83 | 80 | 88 | 89 |
| Specific Gravity | 1.81 | 1.89 | 1.88 | 1.881 | 1.863 | 1.857 | 1.849 |
| Tensile Strength | 1885 | 2909 | 3282 | 2844 | 3617 | 4042 | 3840 |
| (psi) | | | | | | | |
| Elongation (%) | 200 | 287 | 238 | 224 | 272 | 205 | 177 |
| 100% Modulus | 942 | 622 | 978 | 780 | 1229 | 2425 | 2505 |
| 50% Modulus | n/a | 329 | 474 | 369 | 639 | 1418 | 1435 |

Compression Set

| | | | | | | | |
|---|---|---|---|---|---|---|---|
| Spec. 1 | | 11.59 | 11.68 | 8.82 | 8.82 | 11.76 | 8.82 |
| 22 hr/175° F. | | | | | | | |
| Spec. 2 | | 11.59 | 11.68 | 8.82 | 8.82 | 11.76 | 8.82 |
| 22 hr/175° F. | | | | | | | |
| Average | <25% | 11.59 | 11.68 | 8.82 | 8.82 | 11.76 | 8.82 |

We claim:

1. A self-bonding curable fluoroelastomer composition, comprising
a) a fluoropolymer composition having at least one curable fluoropolymer; and
b) a compound selected from the group consisting of aluminum acrylates, silicon acrylates, ammonia acrylates, and combinations thereof, wherein the self-bonding curable fluoroelastomer composition is able to bond directly to a substrate.

2. The self-bonding curable fluoroelastomer composition according to claim 1, wherein the curable fluoropolymer has at least two monomers and at least one curesite monomer, wherein the at least two monomers comprise tetrafluoroethylene and vinylidene fluoride.

3. The self-bonding curable fluoroelastomer composition according to claim 2, wherein the fluoroelastomer composition comprises at least one curing agent.

4. The self-bonding curable fluoroelastomer composition according to claim 3, further comprising at least one of a curing agent, co-curing agent, and a cure accelerator.

5. The self-bonding curable fluoroelastomer composition according to claim 1, comprising at least two curable fluoropolymers.

6. The self-bonding curable fluoroelastomer composition according to claim 5, wherein the at least two curable fluoropolymers are in a blend.

7. The self-bonding curable fluoroelastomer composition according to claim 1, wherein the fluoropolymer composition is a perfluoropolymer composition and the least one curable fluoropolymer comprises a curable perfluoropolymer.

8. The self-bonding curable fluoroelastomer composition according to claim 7, wherein the curable perfluoroelastomer composition comprises at least one curing agent.

9. The self-bonding curable fluoroelastomer composition according to claim 7, wherein the curable perfluoropolymer comprises tetrafluoroethylene, a perfluoroalkylvinylether, and at least one curesite monomer.

10. The self-bonding curable fluoroelastomer composition according to claim 7, comprising at least two curable perfluoropolymers.

11. The self-bonding curable fluoroelastomer composition according to claim 10, wherein the perfluoropolymers are in a blend.

12. The self-bonding curable fluoroelastomer composition according to claim 1, further comprising at least one filler.

13. The self-bonding curable fluoroelastomer composition according to claim 12, wherein the filler is selected from the group consisting of fluoropolymer powders, fluoropolymer micropowders, cross-linkable fluoroplastics, core-shell fluorpolymer fillers, fluoropolymer nanopowders, carbon black, fluorographite, silica, silicates, glass fiber, glass spheres, fiberglass, calcium sulfate, asbestos, boron fibers, ceramic fibers, aluminum hydroxide, barium sulfate, calcium carbonate, magnesium carbonate, alumina, aluminum nitride, borax, perlite, zinc terephthalate, silicon carbide platelets, silicon carbide whiskers, wollastonite, calcium terephthalate, fullerene tubes, Hectorite, talc, mica, carbon nanotubes.

14. The self-bonding fluoroelastomer composition according to claim 1, wherein the self-bonding fluoroelastomer composition is able to bond directly to a substrate selected from the group consisting of ceramic, metals, metal alloys, semiconductors, and polymers.

15. The self-bonding fluoroelastomer composition according to claim 1, wherein the self-bonding fluoroelastomer composition is able to bond directly to alumina, sapphire, boron, silicon, germanium, arsenic, antimony, tellurium, polonium, yttria, yttrium-containing compounds, anodized aluminum, aluminum, stainless steel, and polytetrafluoroethylene.

16. The self-bonding fluoroelastomer composition according to claim 1, wherein there is only one of the compound and it is an aluminum acrylate, a silicon acrylate, or an ammonia acrylate.

17. The self-bonding fluoroelastomer composition according to claim 16, wherein the compound is aluminum acrylate.

18. The self-bonding fluoroelastomer composition according to claim 1, wherein there are about 1 to about 20 parts by weight of the compound based on 100 parts by weight of the at least one curable fluoropolymer.

19. The self-bonding fluoroelastomer composition according to claim 18, wherein there are about 1 to about 5 parts by weight of the compound based on 100 parts by weight of the at least one curable fluoropolymer.

20. The self-bonding fluoroelastomer composition according to claim 1, wherein the composition is heavy-metal free.

21. A self-bonding perfluoroelastomer composition comprising,
a) a perfluoropolymer composition comprising at least one curable perfluoropolymer, wherein the at least one curable perfluoropolymer comprises tetrafluoroethylene, a perfluoroalkylvinylether and at least one curesite monomer;
b) at least one curing agent; and
c) a compound selected from the group consisting of aluminum acrylates, silicon acrylates, ammonia acrylates, and combinations thereof, wherein the self-bonding curable perfluoroelastomer composition is able to bond directly to a substrate.

22. The self-bonding perfluoroelastomer composition according to claim 21, wherein the at least one curing agent is a peroxide-based curing agent and the at least one curesite monomer has a functional group that is capable of crosslinking with the peroxide-based curing agent.

23. The self-bonding perfluoroelastomer composition according to claim 22, wherein the composition comprises at least one of a co-curing agent, and a cure accelerator.

24. The self-bonding perfluoroelastomer composition according to claim 21, wherein the at least one perfluoropolymer is at least one of a terpolymer and a tetrapolymer.

25. The self-bonding perfluoroelastomer composition according to claim 21, comprising at least two curable perfluoropolymers.

26. The self-bonding curable perfluoroelastomer composition according to claim 25, wherein the perfluoropolymers are in a blend.

27. The self-bonding curable perfluoroelastomer composition according to claim 21, further comprising at least one filler selected from the group consisting of fluoropolymer powders, fluoropolymer micropowders, core-shell fluorpolymer fillers, fluoropolymer nanopowders, cross-linkable fluoroplastics, carbon black, fluorographite, silica, silicates, barium sulfate, calcium carbonate, magnesium carbonate, alumina, aluminum nitride, and carbon nanotubes.

28. The self-bonding perfluoroelastomer composition according to claim 21, wherein the self-bonding perfluoroelastomer composition is able to bond directly to a substrate selected from the group consisting of ceramic, metals, metal alloys, semiconductors, and polymers.

29. The self-bonding perfluoroelastomer composition according to claim 21, wherein the self-bonding perfluoroelastomer composition is able to bond directly to alumina, sapphire, boron, silicon, germanium, arsenic, antimony, tellurium, polonium, yttria, yttrium-containing compounds, anodized aluminum, aluminum, stainless steel, and polytetrafluoroethylene.

30. A bonded structure, comprising:
a) a substrate having a surface; and
b) a fluoroelastomer bonded to the surface of the substrate, wherein the fluoroelastomer comprises a compound selected from the group consisting of aluminum acrylates, silicon acrylates, ammonia acrylates, and combinations thereof, and wherein the fluoroelastomer is bonded directly to the substrate.

31. The bonded structure according to claim 30, wherein the substrate is selected from the group consisting of ceramic, metals, metal alloys, semiconductors, and polymers.

32. The bonded structure according to claim 30, wherein the fluoroelastomer is a perfluoroelastomer.

33. The bonded structure according to claim 30, wherein the bonded structure is selected from the group consisting of a laminated structure, a gate valve, a semiconductor chamber door, and a bonded slit valve.

34. The bonded structure according to claim 30, further comprising a second substrate having a surface, wherein the fluoroelastomer is also bonded to the surface of the second substrate.

35. The bonded structure according to claim 34, wherein the bonded structure is a laminated structure having the fluoroelastomer bonded as a layer between the surfaces of the first substrate and the second substrate.

36. A method of bonding a fluoroelastomer to a substrate, comprising
a) preparing a curable fluoropolymer composition by combining at least one curable fluoropolymer with a compound selected from the group consisting of aluminum acrylates, silicon acrylates, ammonia acrylates, and combinations thereof;
b) providing a substrate having a surface; and
c) heat molding the curable fluoropolymer composition to the surface of the substrate so as to at least partially cure the fluoropolymer composition to form a fluoroelastomer and to at least partially bond the fluoropolymer to the surface of the substrate to form a bonded structure having a fluoroelastomer at least partially bonded to the surface of the substrate.

37. The method according to claim 36, wherein the substrate is selected from the group consisting of ceramic, metals, metal alloys, semiconductors, and polymers.

38. The method according to claim 36, wherein the fluoropolymer is a perfluoroelastomer and the bonded structure has a perfluoroelastomer at least partially bonded to the surface of the substrate.

39. The method according to claim 36, further comprising
d) post-curing the bonded structure.

40. The method according to claim 36, wherein the perfluoroelastomer is substantially cured and directly bonded to the surface of the substrate.

41. The method according to claim 36, wherein step b) further comprises providing a second substrate having a surface and step c) further comprises heat molding the curable fluoropolymer composition to the surface of the first substrate and to the surface of the second substrate to form a bonded structure, wherein the fluoropolymer is at least partially bonded to the surfaces of the first and the second substrates.

42. The method according to claim 41, wherein the bonded structure is a laminated structure.
